(19) United States
(12) Patent Application Publication
(10) Pub. No.: US 2026/0168048 A1
(43) Pub. Date: Jun. 18, 2026

(54) HOT ROLLED STEEL SHEET HAVING EXCELLENT FORMABILITY FOR MULTI-STAGE PRESS PROCESS, AND METHOD FOR MANUFACTURING SAME

(71) Applicant: POSCO CO., LTD, Pohang-si, Gyeongsangbuk-do (KR)

(72) Inventors: Tae-Jin SONG, Gwangyang-si (KR); Min-Gyu KIM, Gwangyang-si (KR)

(73) Assignee: POSCO CO., LTD, Pohang-si, Gyeongsangbuk-do (KR)

(21) Appl. No.: 19/126,675

(22) PCT Filed: Nov. 28, 2023
(86) PCT No.: PCT/KR2023/019342

§ 371 Date: May 2, 2025

(30) Foreign Application Priority Data
Nov. 28, 2022 (KR) 10-2022-0161414

(51) Int. Cl. C21D 9/46; C21D 1/18; C21D 1/84; C21D 6/00; C21D 8/1216; C21D 8/1244; C22C 38/00; C22C 38/02; C22C 38/04; C22C 38/06; C22C 38/12; C22C 38/14; C22C 38/22; C22C 38/34; H01F 1/147

(52) U.S. Cl. CPC C21D 9/46; C21D 1/18; C21D 1/84; C21D 6/002; C21D 6/005; C21D 6/008; C21D 8/1222; C21D 8/1261; C22C 38/001; C22C 38/002; C22C 38/02; C22C 38/04; C22C 38/06; C22C 38/12; C22C 38/14; C22C 38/22; C22C 38/34; H01F 1/14775; C22C 2202/02

(57) ABSTRACT

The present invention relates to a hot rolled steel sheet having excellent formability for a multi-stage press process, and a method for manufacturing same.

### TECHNICAL FIELD

The present disclosure relates to a hot rolled steel sheet that may be used for a wheel disk and the like of an automobile, and in more detail, to a high-strength hot rolled steel sheet having excellent multi-stage press formability and a method for manufacturing the same.

### BACKGROUND ART

Recently, to reduce global warming, demand for eco-friendly product production is increasing throughout society. In the automobile industry, much effort in the related art has been made to develop technologies to reduce exhaust gases generated during driving of internal combustion engine vehicles. However, as the recent transition to electric vehicles accelerates, carbon reduction is being considered not only during driving of automobiles but also throughout the entire life cycle thereof, including the production and recycling processes of automobiles. To this end, there is a movement to regulate carbon emissions during the production and recycling processes of raw materials for producing automobiles.

In the related art, the application of lightweight materials such as aluminum has been expanded to reduce carbon emissions during driving of internal combustion engine vehicles. However, the application rate of aluminum to vehicles, which has high carbon emissions during the recent manufacturing process, has been decreasing, and the application rate of steel to vehicles, which has relatively low carbon emissions, has been increasing again.

Among the parts that make up an automobile, the wheel is a safety-critical part that is located in the path that transmits the impact of the ground to the suspension and thus requires high fatigue durability. On the other hand, wheels are parts exposed to the outside of a vehicle, and are parts that require aesthetics including design to stimulate the purchasing desire of vehicle buyers. Passenger car wheel parts are manufactured by the method of casting aluminum alloy materials, and thus various shapes could be implemented to secure the aesthetics that customers demand, and fatigue durability could be secured by casting the parts vulnerable to fatigue thickly.

On the other hand, hot rolled steel sheets used for wheel parts in the related art had excellent strength but lacked formability, so thus it was impossible to form wheel disks with complex shapes through press forming, and therefore, passenger car wheels were mainly manufactured as cast products of aluminum alloy. However, to reduce carbon emissions from an entire life cycle perspective, automobile manufacturers have recently demanded that wheel parts also be manufactured from steel, and thus the development of hot rolled steel sheets with excellent formability compared to steel products of the related art was necessary.

When producing wheel disks using steel plates, they are produced at high speed through multi-stage press forming on press machines arranged in 7 to 10 successive rows to maximize productivity. Meanwhile, to improve the design of the wheel disc and to facilitate air cooling of the wheel disc, it is necessary to machine a large number of holes in the wheel disc. Since the thickness of the steel sheet needs to increase as the area of the hole increases while being able to support the same level of fatigue load, to satisfy the durability required by the customer, a steel plate with a tensile strength of 590 MPa level should normally use a material with a thickness of 3.5 mm or more. When a thick material is continuously press-formed at high speed, forming is done at room temperature in the early stage of forming, but as forming accumulates, the temperature of the material rises due to processing heat, and since thick materials do not cool smoothly, the temperature of the material during forming may rise to 70 to 90° C. Therefore, when considering the formability of steel plates for wheels, it is necessary to consider both formability at room temperature in the early stage of forming and warm high-speed formability that takes processing heat into account during forming.

A method of utilizing the transformation-induced plasticity phenomenon of retained austenite to improve the formability of steel materials has been widely applied. Patent document 1 proposes a method for manufacturing a hot rolled steel sheet containing 50% or more ferrite and 3% or more austenite in volume fraction to obtain both high levels of tensile strength and elongation. However, the aforementioned patent document 1 only considers formability at room temperature and does not mention warm high-speed formability.

Patent document 2 proposes a method for manufacturing a cold rolled steel sheet containing ferrite and/or bainite as the main phase and 3 to 50% of retained austenite in volume fraction to secure the strength in high-speed deformation. However, the aforementioned patent document 2 only considers the strength in terms of crash performance during high-speed forming and does not mention the formability.

Therefore, to manufacture eco-friendly wheel parts, it is necessary to develop a steel that has excellent strength and formability in a multi-stage press process with various forming temperatures.

### PRIOR ART LITERATURE

### Patent Literature

(Patent literature 1) Japanese Patent Publication No. 2002-030385
(Patent literature 2) Japanese Patent Publication No. 1999-193439

### SUMMARY OF INVENTION

### Technical Problem

An aspect of the present disclosure is to provide a hot rolled steel sheet having excellent strength and excellent room temperature formability and warm formability at the same time, and a method for manufacturing the same.

The subject matter of the present disclosure is not limited to the aforementioned contents. Anyone having ordinary knowledge in the technical field to which the present disclosure belongs will have no difficulty in understanding the additional subject matter of the present disclosure from the contents throughout the specification of the present disclosure.

### Solution to Problem

According to an aspect of the present disclosure, a hot rolled steel sheet comprises, in wt %, carbon (C): 0.06 to 0.18%, silicon (Si): 1.2 to 2.5%, manganese (Mn): 0.80 to 2.50%, aluminum (Al): 0.001 to 0.100%, phosphorus (P): 0.0001 to 0.0500%, sulfur(S): 0.0001 to 0.0500%, nitrogen (N): 0.0001 to 0.0200%, and a remainder of Fe and unavoidable impurities, wherein the hot rolled steel sheet has an average carbon content in retained austenite included in a surface layer portion being 1.10 to 1.40 wt %.

According to another aspect of the present disclosure, a method for manufacturing a hot rolled steel sheet comprises an operation of reheating a steel slab comprising, in wt %, carbon (C): 0.06 to 0.18%, silicon (Si): 1.2 to 2.5%, manganese (Mn): 0.80 to 2.50%, aluminum (Al): 0.001 to 0.100%, phosphorus (P): 0.0001 to 0.0500%, sulfur(S): 0.0001 to 0.0500%, nitrogen (N): 0.0001 to 0.0200%, and a remainder of Fe and unavoidable impurities, at 1050 to 1300° C.; an operation of finishing hot rolling the reheated steel slab at a rolling end temperature FDT of 800 to 1150° C.; an operation of first cooling the finishing hot-rolled steel sheet to a temperature T1 of 550 to 750° C. at an average cooling rate of 50 to 150° C./s; after the first cooling, an operation of isothermally maintaining a temperature T2 of 550 to 750° C. for a time ts, or of second cooling to a temperature T2 that is lower than the T1 and is 550 to 750° C. at a cooling rate of 20° C./s or less (excluding 0° C./s) for a time ts; after the isothermally maintaining or the second cooling, an operation of third cooling to a temperature T3, lower than or equal to a temperature Ms at which martensite formation begins, at a cooling rate of 150° C./s or higher; an operation of air-cooling for 2 seconds or more and homogenizing a temperature in a thickness direction of a sheet to T4, after the third cooling; and an operation of coiling the air-cooled hot rolled steel sheet and then performing fourth cooling to room temperature.

### Advantageous Effects of Invention

According to an aspect of the present disclosure, a hot rolled steel sheet having excellent strength and excellent room temperature formability and warm formability at the same time and a method for manufacturing the same may be provided.

The various advantageous advantages and effects of the present disclosure are not limited to the above-described contents, and will be more easily understood in the process of explaining detailed embodiments of the present disclosure.

### BRIEF DESCRIPTION OF DRAWINGS

FIG. 1 is a schematic diagram for measuring thickness of a deep layer portion of a hot rolled steel sheet. FIG. 1A is a schematic diagram of a line intersection length measurement for measuring the size distribution of austenite grains at a specific thickness location. FIG. 1B is a schematic diagram of a microstructure to be implemented in this steel grade. FIG. 1C is a schematic diagram illustrating the average and standard deviation of austenite grain size measured by a line intersection length at specific thickness locations.

FIG. 2 is a photograph of a microstructure of a steel sheet obtained from Inventive Example 2 of the present disclosure observed using a back-electron scattering method, equipped on a scanning electron microscope (SEM). FIG. 2A illustrates a microstructure at a point of 100 μm in a surface layer portion of Inventive Example 2, and FIG. 2B illustrates a microstructure of a deep layer portion of Inventive Example 2. In respective tissue photographs, the white area represents austenite.

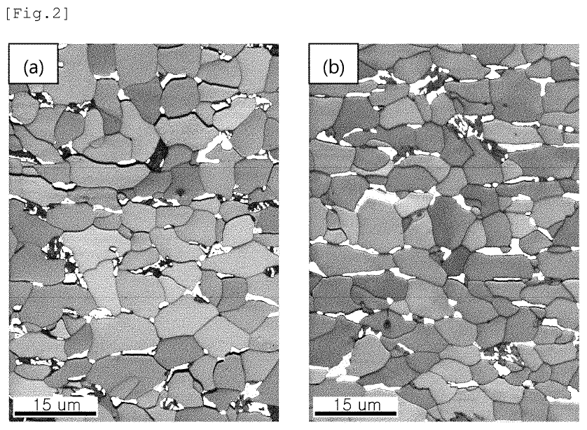

### BEST MODE FOR INVENTION

Hereinafter, preferred embodiments of the present disclosure will be described. However, the embodiments of the present disclosure may be modified in various other forms, and the scope of the present disclosure is not limited to the embodiments described below. In addition, the embodiments of the present disclosure are provided to more completely explain the present disclosure to a person having average knowledge in the relevant technical field.

Meanwhile, the terms used in this specification are for describing specific embodiments, and are not intended to limit the present disclosure. For example, the singular forms used in this specification also include plural forms unless the relevant definition clearly indicates a meaning contrary thereto. In addition, the meaning of “comprising or including” used in the specification specifies a configuration, and does not exclude the presence or addition of other configurations.

The present inventors recognized that in high-strength hot rolled steel sheets of the related art, it is possible to manufacture steel with excellent elongation measured at room temperature using the transformation-induced plasticity (TRIP) phenomenon of retained austenite, but formability under warm forming conditions was not considered, and conducted in-depth research to solve this problem.

The transformation-induced plasticity phenomenon is the principle that retained austenite phase-transforms into martensite when the material is deformed by external stress, thereby increasing the work hardening ability of the steel and preventing local strain concentration and thus improving formability. To optimize formability, the transformation of austenite into martensite should continue along with the deformation of the material. However, if the stability of austenite is too low, the phase transformation is completed at the beginning of the deformation, and thus elongation improvement cannot be expected. If the stability of austenite is too high, the phase transformation does not occur, and thus elongation improvement cannot be expected. Therefore, when designing TRIP steel, the fraction and stability of retained austenite should be considered simultaneously to secure the required formability.

Meanwhile, the stability of austenite is greatly affected by the internal carbon content, and is known to be sensitive to the temperature and speed at which deformation occurs. Normally, if the deformation temperature is high, formability is excellent when lower than the carbon content than that at room temperature, and the deformation speed is known to be less sensitive than the temperature. Therefore, to secure formability at high temperatures, it is advantageous to have a low carbon content in austenite, but considering formability at room temperature, it is advantageous to have a high carbon content in austenite.

To manufacture the steel sheet in which the austenite carbon content in the steel sheet is distributed in an ideal ratio, the inventors of the present disclosure adjusted the structure non-uniformly in the thickness direction. Through this, in the press process where the initial drawing forming is applied, the maximum forming amount is applied to the surface layer portion, so that austenite with a high carbon content is generated for excellent room temperature formability, and to secure warm formability in the subsequent continuous press process, a method was sought in which austenite with a low carbon content may exist inside the steel.

The carbon content inside austenite is affected by the size of the austenite. When the size of the austenite grains is small, carbon confirmation is easy, and thus austenite with a high carbon content exists, and when the size of the austenite grains is large, carbon diffusion inside austenite is not easy, and thus carbon concentration progresses slowly, so that austenite with a low average carbon content exists. Therefore, when the sizes of the austenite grains in the surface layer portion and the deep layer portion are different, austenite with different carbon contents may be generated at respective locations.

To finely disperse the retained austenite of TRIP steel, the Quenching & Partitioning (Q&P) process, which cools to a temperature of Ms or less and then raises the temperature of the steel sheet again to improve strength, elongation, and bendability, is widely used. However, since a separate heating device is required to again raise the temperature of the steel sheet cooled to Ms or less, there was a problem that it was difficult to apply in the hot rolling process where cooling and coiling are performed in series from rolling.

In the manufacturing process of hot rolled steel sheets, after the finishing hot rolling, the hot rolled steel sheet is cooled by cooling water injected from the top and bottom, and at this time, the surface layer portion of the plate is cooled by heat transfer with the cooling water, but the inside of the plate is cooled by heat conduction. In general, since the speed of heat transfer that occurs in the surface layer portion is faster than the heat conduction speed inside the plate, a temperature gradient is generated in the thickness direction inside the plate. However, the inventors of the present disclosure discovered a phenomenon in which, when the cooling water is removed at an appropriate time when the surface layer portion of the plate is cooled to Ms or less, while the deep layer portion of the plate is maintained at a temperature of Ms or more, the surface temperature of the steel plate rises again due to heat transfer within the plate.

That is, even without a separate heating device, the surface layer portion of the steel sheet is cooled to Ms or less and then heated again to a temperature of Ms or more, so that retained austenite exists as finely dispersed austenite with a high carbon content, and the deep layer portion contains coarse austenite with a low carbon content. Thus the present disclosure has been completed by recognizing that a steel plate capable of simultaneously securing formability under both room temperature and warm conditions may be obtained.

First, an alloy composition of the hot rolled steel sheet of the present disclosure will be described. The high-strength hot rolled steel sheet with excellent room temperature and warm formability according to the present disclosure contains, in wt %, carbon (C): 0.06 to 0.18%, silicon (Si): 1.2 to 2.5%, manganese (Mn): 0.80 to 2.50%, aluminum (Al): 0.001 to 0.100%, phosphorus (P): 0.0001 to 0.0500%, sulfur(S): 0.0001 to 0.0500%, nitrogen (N): 0.0001 to 0.0200%, and the remainder Fe and other unavoidable impurities.

Hereinafter, the alloy composition components of the high-strength hot rolled steel sheet with excellent bendability and elongation of the present disclosure and the reasons for limiting the content thereof will be described in detail. Herein, unless otherwise specified, the content of each element means wt %.

### Carbon (C): 0.06 to 0.18%

Carbon (C) is an important element that forms retained austenite by diffusing into austenite during the bainite phase transformation and stabilizing austenite. As the content of C increases, the fraction of retained austenite increases, thereby simultaneously improving elongation and tensile strength. If the content of C is less than 0.06%, the fraction of retained austenite is low, and elongation and tensile strength cannot be secured. On the other hand, if the content thereof exceeds 0.18%, the Ms temperature is excessively lowered, which excessively increases the tensile strength, and there is a problem that formability and weldability are inferior. Therefore, in the present disclosure, the content of C is preferably 0.08 to 0.18%. More preferably, it may be included at 0.08 to 0.15%.

### Silicon (Si): 1.2 to 2.5%

Silicon (Si) is an important element that delays the formation of carbides during bainite transformation and forms retained austenite. In addition, Si plays a role in improving strength through the solid solution strengthening effect. If the content of Si is less than 1.2%, carbides are formed and the fraction of retained austenite is low, and thus it is difficult to secure elongation. On the other hand, if the content exceeds 2.5%, Fe—Si composite oxides are formed on the surface of the slab during reheating, which not only deteriorates the surface quality of the steel sheet, but also deteriorates weldability. Therefore, in the present disclosure, it is preferable that the content of Si is 1.2 to 2.5%. Meanwhile, in terms of further improving the aforementioned effect, the lower limit of the Si content may be 1.8%, or the upper limit of the Si content may be 2.2%.

### Manganese (Mn): 0.80 to 2.50%

Manganese (Mn) is an element that improves the hardenability of steel, and prevents excessive formation of granular ferrite during cooling after finish rolling, thereby facilitating the formation of bainite and retained austenite.

If the content of Mn is less than 0.80%, the hardenability is insufficient, and thus the fraction of granular ferrite increases rapidly during cooling, and there is a problem in which it is difficult to control the complete cooling time at the T2 temperature. On the other hand, if the content exceeds 2.50%, the growth rate of ferrite is too slow, so there is a problem that the time required in the complete cooling section exceeds the time that may be controlled by the equipment. Therefore, in the present disclosure, the content of Mn is preferably 0.80 to 2.50%, and more preferably, may be 1.00 to 2.00%.

### Aluminum (Al): 0.001 to 0.100%

Aluminum (Al) is an element added for deoxidation, and partially exists in the steel after deoxidation. If the content of Al exceeds 0.100%, it causes an increase in oxide and nitride inclusions in the steel, thereby deteriorating the formability of the steel sheet. On the other hand, if the content of Al is excessively reduced to less than 0.001%, it causes an unnecessary increase in refining costs.

Therefore, in the present disclosure, the content of Al is preferably 0.001 to 0.100%.

### Phosphorus (P): 0.0001 to 0.0500%

Phosphorus (P) is an impurity that is inevitably contained, and is an element that is the main cause of lowering the workability of steel due to segregation, so it is desirable to control its content as low as possible. In theory, it is advantageous to limit the content of phosphorus to 0%, but in order to prepare the content of P to less than 0.0001%, the manufacturing cost increases excessively. Therefore, in the present disclosure, the content of P is preferably 0.0001 to 0.0500%.

### Sulfur(S): 0.0001 to 0.0500%

Sulfur(S) is an unavoidable impurity that forms non-metallic inclusions by combining with Mn or the like, and is the main cause of lowering the workability of steel. Therefore, it is desirable to control its content as low as possible. Theoretically, it is advantageous to limit the S content to 0%, but in order to prepare the S content to less than 0.0001%, the manufacturing cost increases excessively. Therefore, in the present disclosure, it is desirable to control the S content to 0.0001 to 0.0500%.

### Nitrogen (N): 0.0001 to 0.0200%

Nitrogen is an unavoidable impurity that reacts with aluminum to precipitate fine nitrides, thereby lowering the workability of steel. Therefore, it is desirable to control the content thereof to be as low as possible. Theoretically, it is advantageous to limit the N content to 0%, but in order to prepare the N content to less than 0.0001%, the manufacturing cost increases excessively. Therefore, in the present disclosure, it is preferable that the N content is 0.0001 to 0.0200%.

In the present disclosure, in addition to the above composition components, at least one of chromium (Cr): 0.01 to 2.00%, molybdenum (Mo): 0.01 to 2.00%, titanium (Ti): 0.01 to 0.20%, and niobium (Nb): 0.01 to 0.10% may be optionally further included. Hereinafter, the contents of respective components and the reason for limiting the contents as optional additional elements will be described in detail.

### Chromium (Cr): 0.01 to 2.00%

Chromium (Cr) is an element that improves the hardenability of steel, and facilitates the formation of austenite by slowing down the formation of ferrite during cooling after finish rolling. If the content of Cr is less than 0.01%, the addition effect cannot be sufficiently obtained. On the other hand, if the content exceeds 2.00%, there is a problem that the phosphate treatment property of the steel sheet is inferior. Therefore, in the present disclosure, the content of Cr is preferably 0.01 to 2.00%, and more preferably 0.10 to 1.50%.

### Molybdenum (Mo): 0.01 to 2.00%

Molybdenum (Mo) is an element that improves the hardenability of steel and plays a role in improving strength through the solid solution strengthening effect. If the content of Mo is less than 0.01%, the addition effect of suppressing ferrite formation during cooling after finish rolling cannot be sufficiently obtained. On the other hand, if the content exceeds 2.00%, there is a problem that the weldability is poor and the cost increases excessively. Therefore, in the present disclosure, the content of Mo is preferably 0.01 to 2.00%, and more preferably 0.05 to 1.00%.

### Titanium (Ti): 0.01 to 0.20%

Titanium (Ti) is an element that forms carbonitrides, and promotes ferrite transformation by making the grains of austenite fine by delaying recrystallization during hot rolling, and improves strength by making the grains of ferrite fine. If the content of Ti is less than 0.01%, the addition effect cannot be sufficiently obtained. On the other hand, if the content Ti of exceeds 0.20%, coarse carbonitrides are generated, which reduces the toughness of the steel sheet. Therefore, in the present disclosure, to obtain the aforementioned effect of adding Ti while further improving the properties, the content of Ti may be 0.01 to 0.20%. On the other hand, in terms of further improving the aforementioned effect, the lower limit of the Ti content may be 0.02%, or the upper limit of the Ti content may be 0.10%.

### Niobium (Nb): 0.01 to 0.10%

Niobium (Nb) is an element that forms carbonitrides similar to Ti. When niobium is added, it promotes ferrite transformation by making the grains of austenite fine by delaying recrystallization during hot rolling, and improves strength by making the grains of ferrite fine.

If the content of Nb is less than 0.01%, the addition effect cannot be sufficiently obtained, while if the content exceeds 0.10%, coarse carbonitrides are generated, which reduces the toughness of the steel sheet and increases the rolling load during rolling, resulting in poor workability. Therefore, in the present disclosure, the content of Nb is preferably 0.01 to 0.10%. Meanwhile, in terms of further improving the aforementioned effect, the content of Nb may be 0.01 to 0.05%.

The remaining component in the present disclosure is iron (Fe). However, since unintended impurities from raw materials or the surrounding environment may inevitably be mixed during the normal manufacturing process, this cannot be ruled out. Since these impurities may be known to anyone skilled in the art of normal manufacturing, not all of the contents are specifically mentioned in this specification.

Although not particularly limited, according to an aspect of the present disclosure, the hot rolled steel sheet may include, as a microstructure of the surface layer portion, a sum of ferrite and bainite: 85.0 to 96.5%, retained austenite: 3.5 to 15.0%, and martensite: 3.0% or less (including 0%), in terms of area %.

According to an aspect of the present disclosure, the microstructure of the surface layer portion may include a sum of ferrite and bainite in a fraction range of 85.0 to 96.5%. Since aluminum alloy has a low specific gravity compared to steel, but also has low strength, when a wheel is manufactured using a steel sheet having a tensile strength of 590 MPa or higher, a weight of a component similar to that of an aluminum alloy wheel may be secured. Therefore, if the elongation may be improved to the maximum extent at a level where the tensile strength satisfies 590 MPa or higher, it is possible to manufacture an environmentally friendly and low-cost wheel part having a weight and design similar to those of an aluminum alloy wheel. In the present disclosure, the improvement of formability is obtained by controlling the phase stability and fraction of retained austenite and also controlling the fraction of ferrite and bainite, which are matrix structures. Ferrite transformation occurs in the stage of slow cooling or isothermal maintenance in the temperature range of 550 to 750° C. after the first cooling after hot rolling, and forms a matrix structure. At this time, carbon diffuses into austenite, so that the Ms temperature, which is the martensite formation temperature, gradually decreases along with the growth of ferrite. In the present disclosure, the coiling temperature is set to the temperature at which the deep layer portion and the surface layer portion supercooled to Ms or less after the third cooling obtain thermal equilibrium. Therefore, if the fraction of ferrite is too low and the Ms temperature is excessively high, there is a problem that carbides are generated in the structure and the fraction of retained austenite decreases. Therefore, the fraction of ferrite may be preferably 70% or more. On the other hand, if the ferrite is excessively excessive, the Ms temperature is too low, so that carbon diffusion of the bainite transformation does not occur smoothly, and thus the fraction of austenite decreases and it may transform into martensite in the final cooling operation. Therefore, the fraction of ferrite generated during the first cooling may be preferably 90% or less.

As described above, the nucleation and growth of martensite occur immediately after the surface layer portion is cooled to Ms or less. However, the temperature rises again to Ms or more due to heat transfer within the steel sheet after cooling, and thus enters the bainite transformation temperature range again before the martensite transformation is completed. Therefore, the martensite formed immediately after cooling is tempered and exists as tempered martensite, and bainitic ferrite grows inside the austenite that has not been transformed at Ms or less. Tempered martensite and bainitic ferrite existing in the surface layer portion have a common lath shape and contain numerous dislocations in the structure, and thus it is difficult to distinguish the same microstructurally, and since the effects thereof on the physical properties are similar, they are not distinguished separately and are collectively referred to as bainite and managed. The fraction of bainite formed after coiling is determined by the maximum carbon content that may be dissolved in austenite, determined by the fraction of austenite immediately after the third cooling and the coiling temperature. Since the effect thereof on the properties of the steel sheet is minimal compared to that of ferrite and retained austenite, it is efficient to manage the sum of the fractions of ferrite and bainite. If the sum of ferrite and bainite is less than 85.08, the carbon content that should be added to the steel to secure stable austenite becomes excessively high, which may hinder the weldability of the steel. If the sum of ferrite and bainite exceeds 96.5%, the fraction of retained austenite cannot be sufficiently secured, which causes a problem in that the formability is inferior.

In addition, according to an aspect of the present disclosure, the microstructure of the surface layer portion may include 3.5 to 15% of retained austenite in terms of area %. Retained austenite plays an important role in improving the formability of steel, and if the fraction of retained austenite is less than 3.5%, there is a problem that the elongation of the steel is inferior. On the other hand, in order for the fraction of retained austenite to exceed 15%, an excessive amount of C should be added, so there is a problem that the strength of the steel sheet increases excessively and the weldability is inferior.

At this time, it is desirable that the average carbon content in the retained austenite included in the surface layer portion satisfies the range of 1.10 to 1.40% in weight %. If the average carbon content in the retained austenite included in the surface layer portion is less than 1.10%, it is not expected to improve the formability because it undergoes transformation-induced plasticity into martensite at the initial stage of deformation at room temperature. On the other hand, if the average carbon content in the retained austenite included in the surface layer portion exceeds 1.40%, the stability is too high and transformation-induced plasticity does not occur even if sufficient deformation occurs, so an improvement in formability cannot be expected, and there is a problem that the formability at room temperature deteriorates.

Meanwhile, in the present disclosure, the surface layer portion mentioned above refers to a region located on the surface layer in the thickness direction from the surface of the hot rolled steel sheet.

According to an aspect of the present disclosure, in the hot rolled steel sheet, the surface layer portion and the deep layer portion may be distinguished through a change in the size of retained austenite. There is no particular limitation on the method for distinguishing the surface layer portion and the deep layer portion, but for example, the distinction may be made by the following method. In detail, first, the austenite structure is distinguished through a LePera etching for the entire thickness of the steel sheet, and then the deep layer portion and the surface layer portion may be distinguished using a tissue photograph measured at 1,000× magnification using an optical microscope.

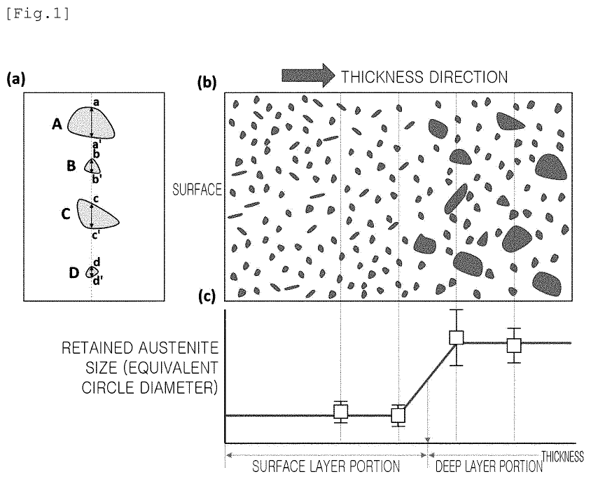

That is, according to an aspect of the present disclosure, the surface layer portion and the deep layer portion may be distinguished through a difference in the size (for example, equivalent circle diameter) of retained austenite. At this time, since it is important to specify the retained austenite equivalent circle diameter at each thickness position of the hot rolled steel sheet, the average and standard deviation of the equivalent circle diameters of the retained austenite at respective thickness positions were measured using the method illustrated in FIG. 1A. To measure the average and standard deviation of the retained austenite sizes (for example, equivalent circle diameters) indicated by A to D, which are different in size, across the dotted line indicating a specific thickness position, the length at which the dotted line intersects each retained austenite was measured, and the arithmetic mean and standard deviation were obtained from the digit of intersecting retained austenites.

In addition, as illustrated in FIG. 1B, when the average and standard deviation at each position starting from a specific position on the surface at equal intervals are obtained, the average and standard deviation of the retained austenite grain size may be expressed according to the distance from the surface, as illustrated in FIG. 1C. From these measurement results, the surface layer portion of the hot rolled steel sheet according to the present disclosure has the characteristics of fine and evenly distributed retained austenite size, and therefore has low average and standard deviation characteristics. In contrast, the deep layer portion of the hot rolled steel sheet according to the present disclosure has a sharp increase in average and standard deviation due to the presence of coarse retained austenite. The position where the average and standard deviation of the retained austenite size (for example, equivalent circle diameter) sharply increases is defined as the surface layer portion. However, the aforementioned line intersection method may simply measure the size (for example, equivalent circle diameter), and is therefore suitable as a method for measuring the depth of the surface layer portion.

However, since the accuracy of measuring the fraction and size (for example, equivalent circle diameter) of the structure is limited, the surface layer portion and deep layer portion microstructures, the average carbon content in the retained austenite and the like may be defined using the following method. At this time, there is no particular limitation on the measurement method, and as an example, in the microstructure of the surface layer portion, the fractions of ferrite and bainite may be distinguished through the analysis results at 1000× magnification using an optical microscope and an image analyzer using the LePera etching method at a position of 50 μm from the surface. The fraction of retained austenite and the austenite equivalent circle diameter (μm) are measured using the same method. In addition, the average carbon content (weight %) in the retained austenite, Cγ, was obtained using Formula 1 below through X-ray diffraction analysis. In addition, the deep layer portion may also be measured using the same method as the surface layer portion described above, and the measurement method is not particularly limited. As an example, in the case of the deep layer portion, the microstructure fraction at the center point (1/2t) of the steel sheet thickness, the retained austenite equivalent circle diameter (μm), and the average carbon content (weight %) in the retained austenite were analyzed using the same method as the surface layer portion.

$$a γ = 3.578 + 0.033 \times [ C γ ] + 0.00 \; 95 \times [ Mn ] - 0.001 \; 24 \times [ Si ] \qquad [ Formula 1 ]$$

(In the above formula 1, ay is the lattice constant (Angstrom) of austenite calculated through X-ray diffraction analysis, and [Mn] and [Si] are the weight contents.)

Although not particularly limited, according to an embodiment of the present disclosure, the average equivalent circle diameter of the retained austenite included in the surface layer portion may be 0.2 to 2.0 μm, more preferably 0.5 μm or more, or 1.8 μm or less. If the average equivalent circle diameter of the retained austenite included in the surface layer portion is less than 0.2 μm, the phase stability increases rapidly, and also, since the internal carbon content is often high, even if sufficient deformation occurs, transformation-induced plasticity does not occur, and it may be difficult to expect an improvement in formability. On the other hand, if the average equivalent circle diameter of the retained austenite in the surface layer portion exceeds 2.0 μm, the carbon diffusion distance increases, and it may be difficult to secure an average carbon content of 1.10% or more in the retained austenite.

In addition, the average equivalent circle diameter of the retained austenite included in the deep layer portion may be larger than the average equivalent circle diameter of the retained austenite included in the surface layer portion described above.

In addition, according to an aspect of the present disclosure, the microstructure of the deep layer portion may include, in terms of area %, a sum of ferrite and bainite: 85.0 to 96.5%, retained austenite: 3.5 to 15.0%, and martensite: 5.0% or less (including 0%). The ferrite is generated in the second cooling operation where the thickness direction temperature is uniform, and thus has the same fraction as the surface layer portion, and the bainite is also generated after the coiling where the thickness direction temperature is uniform, and may thus have a fraction similar to that of the surface layer portion.

In addition, according to an aspect of the present disclosure, the average carbon content in the retained austenite included in the deep layer portion may be less than the average carbon content in the retained austenite included in the surface layer portion. In detail, the average carbon content in the retained austenite in the deep layer portion may be 0.80% or more and less than 1.10%. The temperature of the surface layer portion of the hot rolled steel sheet according to the present disclosure is instantly cooled to Ms or less and then heated again so that austenite is finely distributed and carbon enrichment progresses smoothly, whereas the temperature of the deep layer portion is maintained at a bainite transformation temperature of Ms or more and then coiling is performed, so that austenite exists coarsely and the time required for carbon diffusion increases, and thus the carbon content inside the austenite is lower than that of the surface layer portion, after the final cooling. At this time, if the average carbon content in the retained austenite in the deep layer portion is less than 0.8%, it may not be expected to improve the formability because transformation-induced plasticity into martensite occurs in the early stage of deformation during warm forming. On the other hand, if the average carbon content in the retained austenite in the deep layer portion is 1.1% or more, the stability is too high, so that even if sufficient deformation occurs, transformation-induced plasticity does not occur, so that improvement in formability cannot be expected, and thus, warm formability may deteriorate.

In addition, according to an aspect of the present disclosure, the average equivalent circle diameter of the retained austenite included in the deep layer portion may be more than 2.0 μm and 5.0 μm or less, more preferably 2.2 μm or more, or 3.0 μm or less. If the average equivalent circle diameter of the retained austenite included in the deep layer portion is 2.0 μm or less, carbon enrichment inside the austenite may proceed excessively, and a problem may occur in which the average carbon content in the retained austenite in the deep layer portion becomes 1.10% or more. On the other hand, if the average equivalent circle diameter of the retained austenite included in the deep layer portion exceeds 5.0 μm, the distance required for carbon diffusion increases, and thus it may be difficult to secure an internal carbon content of 0.80% or more of the retained austenite included in the deep layer portion.

According to an embodiment of the present disclosure, an average thickness (t) of the hot rolled steel sheet may be 1.5 to 12.0 mm. If the average thickness of the hot rolled steel sheet is less than 1.5 mm, heat exchange in the thickness direction may be easy, making it difficult to secure a two-component structure of the deep layer portion and the surface layer portion, and if the average thickness of the hot rolled steel sheet exceeds 12.0 mm, it may be difficult to use the steel sheet as a wheel part.

Meanwhile, although not particularly limited, according to an embodiment of the present disclosure, the average thickness of the surface layer portion may be 100 μm or more, and may vary depending on the average thickness of the hot rolled steel sheet, but may be 30% or less of the average thickness of the hot rolled steel sheet. If the average thickness of the surface layer portion is less than 100 μm, the effect of improving the formability at room temperature may be minimal. In addition, if the average thickness of the surface layer portion exceeds 30% of the total average thickness of the hot rolled steel sheet, after heat transfer occurs within the steel sheet, it is difficult to restore the temperature of the surface layer portion to a temperature of Ms or more, so that it is coiled up to a temperature of Ms or less, resulting in a poor shape and deterioration of the formability in the warm forming stage where the amount of deformation is high. Meanwhile, in terms of further improving the above effect, the upper limit of the average thickness of the surface layer portion may be 25%, or the lower limit of the average thickness of the surface layer portion may be 5%. At this time, the surface layer portion may be provided from the two surfaces of the hot rolled steel sheet, respectively. In this case, the average thickness of the surface layer portion mentioned above means the sum of the average thicknesses of respective surface layer portions measured from two surface of the steel sheet in the thickness direction.

Meanwhile, according to an aspect of the present disclosure, if the coiling temperature is too low, carbon diffusion may not be sufficient, and transformation into martensite may occur in some areas, in the final cooling operation to room temperature. This martensite plays a role in improving strength, but if martensite is excessively generated, the fraction of retained austenite decreases, resulting in poor formability. In the present disclosure, there is no need to limit the lower limit of the martensite fraction in the deep layer portion, but if it exceeds 5%, elongation may be poor, management to 5% or less is preferable.

According to an aspect of the present disclosure, in the present disclosure with the alloy composition and microstructure described above, a high-strength hot rolled steel sheet having excellent room temperature and warm formability may be provided, in which the tensile strength is 590 MPa or more, the drawing ratio at room temperature satisfies 2.0 or more, and the elongation measured in the 70 to 90° C. range is 30% or more.

In addition, according to another aspect of the present disclosure, a high-strength hot rolled steel sheet having excellent room temperature and warm formability, which has a tensile strength of 590 MPa or more, a drawing ratio at room temperature satisfying 2.0, and the elongation of 30% or more in a warm tensile test at 80° C., may be provided.

Next, a method for manufacturing a high-strength hot rolled steel sheet having excellent bendability and elongation, according to another aspect of the present disclosure, will be described in detail.

### Reheating of Steel Slab

In the present disclosure, prior to hot rolling, a process of reheating and homogenizing the steel slab is performed, and at this time, it is preferable to perform the reheating process at 1050 to 1300° C. If the reheating temperature is less than 1050° C., there is a problem that the homogenization of alloy elements is not sufficient. On the other hand, if the temperature exceeds 1300° C., excessive oxides are formed on the surface of the slab, which deteriorates the surface quality of the steel sheet, which is not desirable.

### Hot Rolling

Subsequently, the reheated steel slab described above is hot rolled to manufacture a hot rolled steel sheet. At this time, the finishing hot rolling temperature (FDT), which is the temperature of the hot rolled sheet immediately after the finishing hot rolling, is controlled to be between 80° and 1150° C.

If the FDT is performed at a temperature higher than 1150° C. during the hot rolling, excessive oxides are formed on the surface of the steel sheet after rolling, which cannot be effectively removed even after pickling, resulting in poor surface quality. On the other hand, if hot rolling is performed at a temperature lower than the FDT of 800° C., the rolling load increases excessively, which deteriorates the workability.

At this time, it is desirable to manage the sum of the reduction ratios in the last 2 passes of hot rolling in the range of 10 to 40%. The main reason for performing multi-stage hot rolling is to reduce the rolling load and precisely control the thickness. If the sum of the last 2-pass reduction ratios exceeds 40%, the last 2-pass rolling load increases excessively, which causes poor workability. On the other hand, if the sum of the last 2-pass reduction ratios is less than 10%, the temperature of the steel sheet decreases rapidly, which may result in poor workability.

### Cooling Operation

The finishing hot-rolled steel sheet is first cooled to a temperature T1 of 550 to 750° C. at an average cooling rate of 50 to 150° C.

After the first cooling, the steel sheet is isothermally maintained at a temperature T2 [unit: ° C.] of 550 to 750° C. for a time ts [unit: seconds (sec)], or is second cooled to a temperature T2 [unit: ° C.] of 550 to 750° C., lower than the T1 and at an average cooling rate of 20° C./s or less (excluding 0° C./s) for a time ts [unit: seconds (sec)].

During the isothermal maintenance or second cooling, ferrite is generated to form a matrix structure, and carbon is concentrated into austenite, so that the Ms temperature of the steel gradually decreases. At this time, the fraction of ferrite generated during the second cooling is preferably 70 to 90% in area % so that the Ms temperature of the steel may be located between 250 to 450° C., and to this end, it is preferable to control the isothermal maintenance or the temperature and time of second cooling as illustrated in the following relationship 1.

$$70 \leq V α \leq 90 \qquad [ Relationship 1 ]$$

(In the above relationship 1, the Vα represents the fraction [area %] of ferrite generated during the isothermal maintenance or second cooling.)

At this time, the Vα may be defined by the following relationship 2.

$$V α = 100 \times ( 1 - exp ( - k ( T ) \times {( ts )}^{1.5} ) ) \qquad [ Relationship 2 ]$$

(In the above relationship 2, k(T) is an indicator representing the growth rate of ferrite and is defined by the following relationship 3.)

$$k ( T ) = \frac{0.7}{{D}_{U}} exp \{ - {( \frac{( T 1 + T 2 ) / 2 - P}{67} )}^{2} \} \qquad [ Relationship 3 ]$$

(In the above relationship 3, P is defined by the following relationship 4, and Du is an indicator representing the effective grain size of austenite immediately before the first cooling after hot rolling and is defined by the following relationship 5.)

$$P = 633 - 529 \times [ C ] - ( 29 - 32 \times [ C ] ) \times [ M n ] + ( 70 - 86 \times [ C ] ) \times [ S i ] - ( 10 - [ C ] ) \times [ C r ] - ( 15 + [ C ] ) \times [ Mo ] \qquad [ Relationship 4 ]$$

(In the above relationship 4, the [C], [Si], [Mn], [Cr] and [Mo] represent the weight % contents of the elements in parentheses, respectively.)

$$Du = ( F D T + ( 7.4 \times [ C ] ) - ( 24.7 \times [ Si ] ) - ( 4.7 \times [ M n ] ) - ( 3. 9 \times [ C r ] ) - ( 5.2 \times [ M o ] ) - ( 560 \times [ T i ] ) - ( 1110 \times [ N b ] ) ) \times 0.049 - 34.2 \qquad [ Relationship 5 ]$$

(In the above relationship 5, the [C], [Si], [Mn], [Cr], [Mo], [Ti] and [Nb] represent the weight % contents of the elements in parentheses, respectively, and FDT represents the finishing hot rolling temperature (° C.).)

Since the end temperature of the third cooling is set using the fraction of ferrite generated in the second cooling, it is necessary to avoid ferrite transformation in the first cooling operation for precise calculation. Therefore, the average cooling rate of the first cooling is preferably 50° C./s or more. On the other hand, if the average cooling rate is excessive during the first cooling, a temperature difference between the surface layer and the deep layer may occur, and thus the average cooling rate of the first cooling is preferably 150° C./s or less.

According to an aspect of the present disclosure, in the third cooling performed after the second cooling, it is important to perform rapid cooling at an average cooling rate of 150° C./s or more (or, 150 to 250° C./s) so that the temperature of the surface layer portion is as illustrated in the following relationship 6 to implement the microstructure intended in the present disclosure.

$$Ms - 100 \leq T 3 \leq Ms - 30 \qquad [ Relationship 6 ]$$

(In the above relationship 6, the T3 is the temperature [° C.] of the steel sheet measured at the surface after the completion of the third cooling, and Ms is the temperature [° C.] at which martensite formation starts in the austenite present in the steel sheet after the completion of the second cooling, and is defined by the following relationship 7.)

$$Ms ( ° C . ) = 550 - ( 330 \times [ {C}^{′} ] ) - ( 41 \times [ Mn ] ) - ( 20 \times [ S i ] ) - ( 20 \times [ C r ] ) - ( 10 \times [ M o ] ) + ( 30 \times [ Al ] ) \qquad [ Relationship 7 ]$$

(In the above relationship 7, [C′] represents a value considering the concentration of carbon diffused in the ferrite, and is defined through the following relationship 8. In addition, the [Mn], [Si], [Cr], [Mo], and [Al] represent the weight % contents of the elements in parentheses, respectively.)

$$[ {C}^{′} ] = 0.9 \times ( [ C ] - V α \times 0.02 ) / ( 1 - V α ) \qquad [ Relationship 8 ]$$

(In the above relationship 8, the [Cl represents the weight % content of the element in the parentheses, and the Vα is as described above.)

According to an aspect of the present disclosure, the average cooling rate of the third cooling may be 150° C./s or more (or, between 15° and 250° C./s). If the average cooling rate of the third cooling is less than 150° C./s, a sufficient thickness of the surface layer portion cannot be secured, which may deteriorate room temperature formability. Conversely, if the average cooling rate of the third cooling exceeds 250° C./s, the surface layer portion thickness may be excessive, making it difficult to secure warm formability.

### Homogenization Operation

According to an aspect of the present disclosure, after the third cooling, the temperature in the thickness direction of the plate may be homogenized to T4 by air cooling for 2 seconds or more (the upper limit is not particularly limited), and the T4 may be in the range of 200 to 400° C. The temperature in the thickness direction may be homogenized by heat transfer within the steel sheet due to air cooling in the homogenization operation described above. The surface layer portion cooled to a temperature of Ms or less is reheated to a temperature of Ms or more due to the heat transferred from the deep layer portion, and carbon diffusion from martensite in a carbon-overabsorbed state to austenite becomes easy, and the austenite may be stabilized.

### Coiling and Final Cooling Operation

Subsequently, in the present disclosure, the air-cooled hot rolled steel sheet may be coiled and then undergo fourth cooling to room temperature. That is, the hot rolled steel sheet homogenized to a temperature of T4 after the third cooling is coiled to manufacture a coil, and then cooled to room temperature.

Next, in the present disclosure, the hot rolled steel sheet that has undergone the final cooling (fourth cooling) may be optionally subjected to additional pickling and oiling to manufacture a Pickled and Oiled (PO) steel sheet.

Alternatively, the hot rolled steel sheet that has undergone the final cooling may be optionally heated to a temperature range of 400 to 750° C. after pickling to perform hot-dip galvanizing.

### MODE FOR INVENTION

Hereinafter, the present disclosure will be described in more detail through examples. However, it should be noted that the following examples are only intended to explain the present disclosure through examples and are not intended to limit the scope of the rights of the present disclosure. This is because the scope of the rights of the present disclosure is determined by the matters described in the patent claims and matters reasonably inferred therefrom.

### EXAMPLE

steel slab having an alloy composition as illustrated in Table 1 below was prepared. Then, a hot rolled steel sheet having a thickness of 4 mm was manufactured using the prepared steel slab under the manufacturing conditions as illustrated in Table 2 below. At this time, the reheating temperature of the steel slab was set to 1150° C., the sum of the reduction ratios of the final 2 passes of the finishing rolling was set to 258, and the average cooling rate of the first cooling was applied at 60° C./s.

The third cooling was performed by applying the same amount of water and moving speed of the steel sheet, and then changing the cooling speed of the steel sheet by changing the water injection time. The temperature of the surface layer of the steel sheet measured after the end of the water injection was designated as T3, and the temperature (homogenization temperature) immediately before coiling after 2 seconds or more had passed was designated as T4.

The microstructure of each steel sheet manufactured according to the description above was observed, and the results are illustrated in Table 3 below. In this case, in Table 3 below, F represents ferrite, B represents bainite, P represents pearlite, and A represents austenite.

In addition, the thickness and ratio of the surface layer portion were measured and are illustrated in Table 3 below. The thickness of the surface layer portion was obtained by randomly selecting 10 points, measuring the thickness of the surface layer portion, and then providing the average value thereof. The ratio of the surface layer portion was obtained by calculating a ratio using the average value of the thickness of the surface layer portion.

In addition, respective steel sheets manufactured as described above were processed into discs with diameters of 200 mm and 160 mm and cup-formed with a punch with diameter of 100 mm to verify drawing formability at room temperature. If the disc with diameter of 160 mm was cup-formed without cracks, it was determined that the drawing ratio (DR) satisfied 1.6. If the disc with diameter of 200 mm was cup-formed without cracks, it was determined that the drawing ratio satisfied 2.0. The results are marked as O and X in Table 4.

To verify the warm formability, specimens with a gauge width of 20 mm and a gauge length of 50 mm were manufactured in a direction parallel to the rolling direction, and maintained in a furnace maintained at 80° C. for 1 hour to make the temperature uniform. Then, a tensile test was performed at a strain rate of 50 mm per minute at gage speed in the furnace, and the yield strength (YS), tensile strength (TS), uniform elongation (U-El), and elongation (El) were measured. The results are illustrated in Table 4. In detail, the yield strength and tensile strength represent the lower yield point and maximum tensile strength, respectively, and elongation represents the fracture elongation.

The drawing ratio of room temperature forming satisfied 2.0, and the tensile strength of the warm tensile test was determined to be 590 MPa or more and the elongation was determined to be 30% or more, at good levels.

TABLE 1

| Steel | | | | | | Sol. | | | | | |
|---|---|---|---|---|---|---|---|---|---|---|---|
| Grade | C | Si | Mn | P | S | Al | Cr | Mo | Ti | Nb | N |
| Invention | 0.11 | 2.0 | 1.15 | 0.0008 | 0.0002 | 0.012 | 0 | 0 | 0 | 0 | 0.0021 |
| Steel 1 | | | | | | | | | | | |
| Invention | 0.09 | 2.0 | 1.50 | 0.0011 | 0.0003 | 0.015 | 0 | 0 | 0 | 0 | 0.0034 |
| Steel 2 | | | | | | | | | | | |
| Invention | 0.12 | 2.1 | 0.90 | 0.0009 | 0.0002 | 0.012 | 0 | 0 | 0 | 0 | 0.0028 |
| Steel 3 | | | | | | | | | | | |
| Invention | 0.15 | 2.2 | 0.90 | 0.0012 | 0.0002 | 0.012 | 0.20 | 0 | 0 | 0 | 0.0026 |
| Steel 4 | | | | | | | | | | | |
| Invention | 0.09 | 2.1 | 1.20 | 0.0013 | 0.0003 | 0.015 | 0 | 0 | 0.03 | 0 | 0.0025 |
| Steel 5 | | | | | | | | | | | |
| Invention | 0.10 | 2.1 | 1.20 | 0.0012 | 0.0003 | 0.012 | 0 | 0 | 0 | 0.02 | 0.0032 |
| Steel 6 | | | | | | | | | | | |
| Invention | 0.12 | 1.8 | 1.20 | 0.0012 | 0.0003 | 0.012 | 0.10 | 0.10 | 0 | 0 | 0.0032 |
| Steel 7 | | | | | | | | | | | |
| Comparative | 0.05 | 2.0 | 1.20 | 0.0009 | 0.0003 | 0.014 | 0 | 0 | 0 | 0 | 0.0026 |
| Steel 1 | | | | | | | | | | | |
| Comparative | 0.12 | 0.5 | 1.50 | 0.0009 | 0.0002 | 0.014 | 0 | 0 | 0 | 0 | 0.0032 |
| Steel 2 | | | | | | | | | | | |

TABLE 2

| | | | | | | | Third | | | | |
|---|---|---|---|---|---|---|---|---|---|---|---|
| | | | | Isothermal | | | Cooling | | | | |
| | | | | Maintenance or | | | (Water | | | | |
| | | | | Second Cooling | | | Cooling) | | | | |
| | | | | | time, | cooling | | Cooling | | | |
| Classi- | Steel | FDT | | | ts | Rate | | Rate | | Vα | Ms |
| fication | Grade | [° C.] | T1* | T2* | [s] | [° C./s] | T3* | [° C./s] | T4* | [area %] | [° C.] |
| Inventive | Invention | 880 | 670 | 650 | 6.0 | 3.3 | 233.2 | 181 | 328 | 80.3 | 322 |
| Example 1 | Steel 1 | | | | | | | | | | |
| Inventive | Invention | 880 | 650 | 650 | 7.0 | 0.0 | 215.8 | 161 | 299 | 85.1 | 287 |
| Example 2 | Steel 2 | | | | | | | | | | |
| Inventive | Invention | 880 | 700 | 680 | 6.0 | 3.3 | 230.9 | 180 | 325 | 78.6 | 311 |
| Example 3 | Steel 3 | | | | | | | | | | |
| Inventive | Invention | 880 | 670 | 660 | 5.0 | 2.0 | 226.4 | 173 | 317 | 71.8 | 307 |
| Example 4 | Steel 4 | | | | | | | | | | |
| Inventive | Invention | 880 | 670 | 650 | 6.0 | 3.3 | 248.1 | 201 | 354 | 81.5 | 328 |
| Example 5 | Steel 5 | | | | | | | | | | |
| Inventive | Invention | 880 | 680 | 660 | 6.0 | 3.3 | 213.9 | 159 | 295 | 86.5 | 257 |
| Example 6 | Steel 6 | | | | | | | | | | |
| Inventive | Invention | 885 | 680 | 660 | 7.0 | 2.9 | 226.4 | 173 | 317 | 81.1 | 281 |
| Example 7 | Steel 7 | | | | | | | | | | |
| Comparative | Comparative | 880 | 700 | 680 | 8.0 | 2.5 | 256.2 | 212 | 368 | 91.0 | 344 |
| Example 1 | Steel 1 | | | | | | | | | | |
| Comparative | Comparative | 880 | 620 | 600 | 8.0 | 2.5 | 302.3 | 198 | 416 | 69.1 | 366 |
| Example 2 | Steel 2 | | | | | | | | | | |
| Comparative | Invention | 880 | 700 | 680 | 8.0 | 2.5 | 96.5 | 154 | 163 | 90.7 | 146 |
| Example 3 | Steel 3 | | | | | | | | | | |
| Comparative | Invention | 880 | 700 | 680 | 7.0 | 2.9 | 90.5 | 295 | 259 | 85.7 | 258 |
| Example 4 | Steel 3 | | | | | | | | | | |
| Comparative | Invention | 880 | 680 | 660 | 6.0 | 3.3 | 278.1 | 83 | 313 | 80.9 | 310 |
| Example 5 | Steel 3 | | | | | | | | | | |

T1*: 1st cooling end temperature [° C.]
T2*: Isothermal maintenance temperature [° C.] or 2nd cooling end temperature [° C.]
T3*: 3rd cooling end temperature [° C.]
T4*: Homogenization temperature [° C.]

TABLE 3

| | | | | | | | | Surface | | | | | | | Deep | |
|---|---|---|---|---|---|---|---|---|---|---|---|---|---|---|---|---|
| | | | | | | | | Layer | | | | | | | Layer | |
| | | | | | | | | Portion | | | | | | | Portion | |
| | | | | | | | | Phase A | | | | | | | A Phase | |
| | | | | | | | | Average | | | | | | | Average | |
| | Surface | | | | | | | Equiv- | In A | | | | | | Equiv- | In A |
| | Layer | Surface | Surface layer portion | | | | | alent | phase, | Deep layer portion | | | | | alent | phase, |
| | Portion | Layer | microstructure fraction | | | | | Circle | Aver- | microstructure fraction | | | | | Circle | Aver- |
| | Thick- | Portion | [area %] | | | | | Diam- | age C | [area %] | | | | | Diam- | age C |
| Classi- | ness | Ratio | Phase | Phase | Phase | Phase | Phase | eter | content | Phase | Phase | Phase | Phase | Phase | eter | content |
| fication | [mm] | [%] | F | B | P | M | A | [μm] | [wt %] | F | B | P | M | A | [μm] | [wt %] |
| Inventive | 0.50 | 25 | 80.0 | 12.5 | 0.0 | 0.4 | 7.0 | 1.5 | 1.22 | 80.2 | 10.7 | 0.0 | 1.4 | 7.8 | 2.4 | 1.01 |
| Example 1 | | | | | | | | | | | | | | | | |
| Inventive | 0.41 | 21 | 85.7 | 8.5 | 0.0 | 0.5 | 5.3 | 1.4 | 1.23 | 84.6 | 8.4 | 0.0 | 1.1 | 6.0 | 2.5 | 1.02 |
| Example 2 | | | | | | | | | | | | | | | | |
| Inventive | 0.43 | 22 | 79.2 | 12.5 | 0.0 | 0.6 | 7.7 | 1.4 | 1.23 | 78.4 | 12.1 | 0.0 | 1.4 | 8.0 | 2.7 | 1.08 |
| Example 3 | | | | | | | | | | | | | | | | |
| Inventive | 0.46 | 23 | 71.8 | 17.4 | 0.0 | 0.5 | 10.3 | 1.5 | 1.23 | 71.7 | 15.6 | 0.0 | 1.9 | 10.9 | 2.4 | 1.04 |
| Example 4 | | | | | | | | | | | | | | | | |
| Inventive | 0.38 | 19 | 81.5 | 12.5 | 0.0 | 0.2 | 5.8 | 1.7 | 1.19 | 81.8 | 11.0 | 0.0 | 1.1 | 6.1 | 2.4 | 0.99 |
| Example 5 | | | | | | | | | | | | | | | | |
| Inventive | 0.16 | 8 | 86.2 | 7.2 | 0.0 | 0.2 | 6.4 | 1.2 | 1.23 | 86.8 | 5.4 | 0.0 | 1.2 | 6.6 | 2.5 | 1.05 |
| Example 6 | | | | | | | | | | | | | | | | |
| Inventive | 0.22 | 11 | 81.3 | 10.5 | 0.0 | 0.8 | 7.5 | 1.4 | 1.23 | 81.1 | 9.2 | 0.0 | 1.5 | 8.3 | 2.5 | 1.04 |
| Example 7 | | | | | | | | | | | | | | | | |
| Compar- | 0.42 | 21 | 90.3 | 7.0 | 0.0 | 0.2 | 2.5 | — | 1.16 | 90.3 | 6.6 | 0.0 | 0.5 | 2.6 | — | 0.99 |
| ative | | | | | | | | | | | | | | | | |
| Example 1 | | | | | | | | | | | | | | | | |
| Compar- | 0.25 | 13 | 82.5 | 6.3 | 7.2 | 2.8 | 1.2 | — | 1.01 | 81.5 | 7.0 | 7.8 | 2.5 | 1.2 | — | 0.86 |
| ative | | | | | | | | | | | | | | | | |
| Example 2 | | | | | | | | | | | | | | | | |
| Compar- | 0.25 | 13 | 90.0 | 0.0 | 0.0 | 9.4 | 0.6 | — | 0.62 | 90.8 | 0.0 | 0.0 | 9.2 | 0.0 | — | 0.53 |
| ative | | | | | | | | | | | | | | | | |
| Example 3 | | | | | | | | | | | | | | | | |
| Compar- | 0.85 | 43 | 85.8 | 5.5 | 0.0 | 0.4 | 8.2 | 1.2 | 1.07 | 85.3 | 4.6 | 0.0 | 1.5 | 8.6 | 2.7 | 1.01 |
| ative | | | | | | | | | | | | | | | | |
| Example 4 | | | | | | | | | | | | | | | | |
| Compar- | 0.08 | 4 | 80.5 | 11.2 | 0.0 | 0.1 | 8.1 | 1.4 | 1.02 | 80.3 | 10.1 | 0.0 | 1.4 | 8.2 | 2.4 | 1.06 |
| ative | | | | | | | | | | | | | | | | |
| Example 5 | | | | | | | | | | | | | | | | |

Phase A: retained austenite

TABLE 4

| | Room | | | | | |
|---|---|---|---|---|---|---|
| | Temperature | | Warm Tensile Test | | | |
| Classi- | Drawing Test | | YP | TS | U-El | El |
| fication | DR = 1.6 | DR = 2.0 | [MPa] | [MPa] | [%] | [%] |
| Inventive | ◯ | ◯ | 456 | 629 | 23 | 37 |
| Example 1 | | | | | | |
| Inventive | ◯ | ◯ | 478 | 612 | 21 | 36 |
| Example 2 | | | | | | |
| Inventive | ◯ | ◯ | 459 | 642 | 23 | 37 |
| Example 3 | | | | | | |
| Inventive | ◯ | ◯ | 495 | 678 | 25 | 38 |
| Example 4 | | | | | | |
| Inventive | ◯ | ◯ | 457 | 640 | 21 | 36 |
| Example 5 | | | | | | |
| Inventive | ◯ | ◯ | 462 | 623 | 22 | 37 |
| Example 6 | | | | | | |
| Inventive | ◯ | ◯ | 469 | 645 | 23 | 38 |
| Example 7 | | | | | | |
| Comparative | ◯ | ◯ | 389 | 536 | 16 | 29 |
| Example 1 | | | | | | |
| Comparative | X | X | 425 | 581 | 13 | 27 |
| Example 2 | | | | | | |
| Comparative | ◯ | X | 392 | 730 | 15 | 26 |
| Example 3 | | | | | | |
| Comparative | ◯ | ◯ | 452 | 642 | 18 | 29 |
| Example 4 | | | | | | |
| Comparative | ◯ | X | 462 | 635 | 24 | 38 |
| Example 5 | | | | | | |

As illustrated in Tables 1 to 4 above, it can be seen that Inventive Examples 1 to 7, which satisfies both the alloy composition and manufacturing conditions proposed in the present disclosure, include a microstructure of the surface layer portion with an average thickness of 100 μm or more from the steel surface and within 30% or less of the total thickness.

In addition, the microstructure present in the surface layer portion includes, in area %, a sum of ferrite and bainite of 85.0 to 96.5%, retained austenite of 3.5 to 15.0%, and martensite of less than 3.0%, and the average carbon content in the retained austenite satisfies 1.10 to 1.40% in weight %, and thus it can be confirmed that excellent formability may be secured at room temperature. Meanwhile, the deep layer portion contains, in area %, 85.0 to 96.5% of the sum of ferrite and bainite; and 3.5 to 15.0% of retained austenite that has an average carbon content of 0.80 to 1.10 weight %, and thus it can be confirmed that the warm formability is also excellent.

In contrast, Comparative Example 1 could not secure sufficient retained austenite because the C content was 0.06% or less, and thus, although the drawing formability at room temperature was good, it could not secure strength of 590 MPa or more and elongation of 30% or more during warm forming.

In Comparative Example 2, since pearlite was generated during coiling when Si was less than 1.2%, a sufficient amount of austenite could not be secured. As a result, drawing formability at room temperature and strength of 590 MPa or more and elongation of 30% or more during warm forming could not be secured.

Comparative Example 3 had an excessively high ferrite fraction during the second cooling, and thus the coiling temperature was low. As a result, the bainite transformation after coiling was not smooth, and most of the austenite was transformed into martensite. As a result, the drawing formability was poor, and 30% of elongation could not be secured during warm forming.

On the other hand, in the case of Comparative Examples 1 to 3 mentioned above, the retained austenite fractions in the surface layer portion and deep layer portion were too small, less than 0.2 μm, and the size was so small that the equivalent circle diameter of the retained austenite could not be reliably measured.

Comparative Example 4 had an excessive cooling rate during the third cooling, and as a result, the drawing formability at room temperature was excellent, but sufficient elongation could not be secured during the warm tensile test.

Comparative Example 5 had a slow cooling rate during the third cooling, and as a result, the warm formability was excellent, but sufficient formability could not be secured during the cold forming.

Meanwhile, FIG. 1 is a photograph of the microstructure of Inventive Example 2 observed by back electron scattering, mounted on a scanning electron microscope.

FIG. 1A is a microstructure at a point 50 μm in depth from a surface of the surface layer portion of Inventive Example 2, and the average equivalent circle diameter of retained austenite was measured to be 1.4 μm. Meanwhile, the average carbon content in the retained austenite included in the surface layer portion, calculated by measuring the austenite lattice constant of X-ray diffraction, was 1.23 wt %.

FIG. 1B is a microstructure of the deep layer portion (corresponding to the center of the thickness (1/2t) in the present disclosure) of Inventive Example 2, and shows the microstructure of the deep layer portion. The average equivalent circle diameter of retained austenite included in the deep layer portion was 2.5 μm, and the average carbon content in the retained austenite included in the deep layer portion, measured by X-ray diffraction, was 1.02 wt %. It can be confirmed that the surface layer portion is cooled to Ms or less and has a high carbon content due to fine distribution of austenite, while the deep layer portion, which is maintained at a temperature of Ms or more, has a low carbon content due to coarse distribution of retained austenite.

As described above, in the detailed description of the present disclosure, preferred embodiments of the present disclosure have been described, but it will be apparent to those skilled in the art that various modifications may be made without departing from the scope of the present disclosure. Therefore, the scope of the rights of the present disclosure should not be limited to the described embodiments, but should be determined by the claims described below as well as equivalents thereof.

1. A hot rolled steel sheet comprising:
in wt %, carbon (C): 0.06 to 0.18%, silicon (Si): 1.2 to 2.5%, manganese (Mn): 0.80 to 2.50%, aluminum (Al): 0.001 to 0.100%, phosphorus (P): 0.0001 to 0.0500%, sulfur(S): 0.0001 to 0.0500%, nitrogen (N): 0.0001 to 0.0200%, and a remainder of Fe and unavoidable impurities,
wherein the hot rolled steel sheet has an average carbon content in retained austenite comprised in a surface layer portion being 1.10 to 1.40 wt %.

2. The hot rolled steel sheet of claim 1, wherein a microstructure of the surface layer portion comprises, in area %, a sum of ferrite and bainite: 85.0 to 96.5%, retained austenite: 3.5 to 15.0%, and martensite: 3.0% or less (including 0%).

3. The hot rolled steel sheet of claim 1, further comprising, in terms of weight %, at least one selected from the group consisting of chromium (Cr): 0.01 to 2.00%, molybdenum (Mo): 0.01 to 2.00%, titanium (Ti): 0.01 to 0.20%, and niobium (Nb): 0.01 to 0.10%.

4. The hot rolled steel sheet of claim 1, wherein an average carbon content in retained austenite comprised in a deep layer portion is less than the average carbon content in the retained austenite included in the surface layer portion.

5. The hot rolled steel sheet of claim 1, wherein an average carbon content in retained austenite included in a deep layer portion is, in wt %, 0.8% or more and less than 1.10%.

6. The hot rolled steel sheet of claim 1, wherein a microstructure of a deep layer portion comprises, in area %, a sum of ferrite and bainite: 85.0 to 96.5%, retained austenite: 3.5 to 15.0%, and martensite: 5.0% or less (including 0%).

7. The hot rolled steel sheet of claim 1, wherein a thickness of the surface layer portion is 30% or less of a thickness of the hot rolled steel sheet.

8. The hot rolled steel sheet of claim 1, wherein an average equivalent circle diameter of retained austenite included in a deep layer portion is larger than an average equivalent circle diameter of the retained austenite included in the surface layer portion.

9. The hot rolled steel sheet of claim 1, wherein an average equivalent circle diameter of the retained austenite included in the surface layer portion is 0.2 to 2.0 μm.

10. The hot rolled steel sheet of claim 1, wherein an average equivalent circle diameter of retained austenite included in a deep layer portion is more than 2.0 μm and less than or equal to 5.0 μm.

11. A method for manufacturing a hot rolled steel sheet, comprising:
an operation of reheating a steel slab comprising, in wt %, carbon (C): 0.06 to 0.18%, silicon (Si): 1.2 to 2.5%, manganese (Mn): 0.80 to 2.50%, aluminum (Al): 0.001 to 0.100%, phosphorus (P): 0.0001 to 0.0500%, sulfur(S): 0.0001 to 0.0500%, nitrogen (N): 0.0001 to 0.0200%, and a remainder of Fe and unavoidable impurities, at 1050 to 1300° C.;
an operation of finishing hot rolling the reheated steel slab at a rolling end temperature FDT of 800 to 1150° C.;
an operation of first cooling the finishing hot-rolled steel sheet to a temperature T1 of 550 to 750° C. at an average cooling rate of 50 to 150° C./s;
after the first cooling, an operation of isothermally maintaining a temperature T2 of 550 to 750° C. for a time ts, or of second cooling to a temperature T2 that is lower than the T1 and is 550 to 750° C. at a cooling rate of 20° C./s or less (excluding 0° C./s) for a time ts;
after the isothermally maintaining or the second cooling, an operation of third cooling to a temperature T3, lower than or equal to a temperature Ms at which martensite formation begins, at a cooling rate of 150° C./s or higher;
an operation of air-cooling for 2 seconds or more and homogenizing a temperature in a thickness direction of a sheet to T4, after the third cooling; and
an operation of coiling the air-cooled hot rolled steel sheet and then performing fourth cooling to room temperature.

12. The method for manufacturing a hot rolled steel sheet of claim 11, wherein the operation of isothermally maintaining or second cooling satisfies the following relationship 1,
$$70 \leq V α \leq 90 \qquad [ Relationship 1 ]$$
where the Vα represents a fraction of ferrite generated during isothermal maintenance or second cooling.

13. The method for manufacturing a hot rolled steel sheet of claim 12, wherein the Vα is defined by the following relationship 2,
$$V α = 100 \times ( 1 - exp ( - k ( T ) \times {( ts )}^{1.5} ) ) \qquad [ Relationship 2 ]$$
where k(T) is an indicator representing a growth rate of ferrite and is defined by the following relationship 3,
$$k ( T ) = \frac{0.7}{{D}_{U}} exp \{ - {( \frac{( T 1 + T 2 ) / 2 - P}{67} )}^{2} \} , \qquad [ Relationship 3 ]$$
where P is defined by the following relationship 4, and Du is an indicator representing an effective grain size of austenite immediately before the first cooling after hot rolling and is defined by the following relationship 5,
$$P = 633 - 529 \times [ C ] - ( 29 - 32 \times [ C ] ) \times [ M n ] + ( 70 - 86 \times [ C ] ) \times [ S i ] - ( 10 - [ C ] ) \times [ C r ] - ( 15 + [ C ] ) \times [ Mo ] \qquad [ Relationship 4 ]$$
where the [C], [Si], [Mn], [Cr], and [Mo] represent weight % contents of elements in parentheses, respectively,
$$Du = ( F D T + ( 7.4 \times [ C ] ) - ( 24.7 \times [ Si ] ) - ( 4.7 \times [ M n ] ) - ( 3. 9 \times [ C r ] ) - ( 5.2 \times [ M o ] ) - ( 560 \times [ T i ] ) - ( 1110 \times [ N b ] ) ) \times 0.049 - 34.2 \qquad [ Relationship 5 ]$$
where the [C], [Si], [Mn], [Cr], [Mo], [Ti] and [Nb] represent weight % contents of elements in parentheses, respectively, and FDT represents a rolling end temperature (° C.).
